(19) United States
(12) Patent Application Publication
(10) Pub. No.: US 2025/0168560 A1
(43) Pub. Date: May 22, 2025

(54) Computer-Implemented Audio Adjustment Method and Audio Adjustment Apparatus

(71) Applicant: Yamaha Corporation, Hamamatsu-shi (JP)

(72) Inventors: Nobuaki HIMENO, Hamamatsu-shi (JP); Hidetaka IMAMURA, Hamamatsu-shi (JP); Toshifumi KANNO, Hamamatsu-shi (JP)

(21) Appl. No.: 18/947,076

(22) Filed: Nov. 14, 2024

(30) Foreign Application Priority Data
Nov. 17, 2023 (JP) 2023-195644

(51) Int. Cl. H04R 3/00

(52) U.S. Cl. CPC H04R 3/00

(57) ABSTRACT

An audio-adjustment method includes causing N sound characteristics to be in one-to-one correspondence with N specific points within an operation area, N being a natural number not less than three, receiving an operation to specify as a selected point a location within the operation area, identifying as a selected characteristic a sound characteristic corresponding to the selected point based on at least one specific point among the N specific points, at least one sound characteristic corresponding to the at least one specific point, and the selected point, determining whether the selected characteristic is to be a target-sound characteristic, in response to the selected characteristic not being to be the target-sound characteristic, executing, based on the selected characteristic and the N sound characteristics, processing to update at least one of the N sound characteristics to at least one sound characteristic other than the N sound characteristics, and receiving the operation again.

### CROSS REFERENCE TO RELATED APPLICATION

This Application is based on, and claims priority from, Japanese Patent Application No. 2023-195644, filed on Nov. 17, 2023, the entire contents of which are incorporated herein by reference.

### TECHNICAL FIELD

This disclosure relates to an audio adjustment method and to an audio adjustment apparatus.

### BACKGROUND

There is known in the art an audio adjustment apparatus, such as an equalizer, which is used for applying sound effects. By use of such an audio adjustment apparatus, a user is able to adjust values of audio parameters and achieve a corresponding desired sound characteristic. An example of a sound characteristic is a sound quality. For example, Japanese Patent Application Laid-Open Publication No. H09-051239 discloses a method that includes displaying one-dimensional subjective category axes corresponding to a word pair descriptive of a quality of sound that the user wishes to hear, and having a sensitivity value assignable on the axes by use of a cursor or the like.

In the conventional method in which values of sound parameters are specified by selection of values on axes, the sound parameters are determined in advance. Thus, for example, when a number of axes displayed on an operation screen is small, a number of sound parameters that can be adjusted is small as compared to a case in which a number of axes displayed on the operation screen is large. As a result, it may not be possible for a user to achieve a desired sound characteristic. On the other hand, for example, when a number of axes displayed on the operation screen is large, a number of sound parameters that can be adjusted increases, and an operation required to be carried out by the user to achieve a desired sound characteristic may become overly complicated. In this case, the operation may be interrupted before the sound characteristic desired by the user is achieved, and thus it may not be possible for the desired sound characteristic to be achieved.

### SUMMARY

An object of one aspect of this disclosure is to achieve a sound characteristic desired by a user with high accuracy.

In one aspect, a computer-implemented audio adjustment method includes causing N sound characteristics to be in one-to-one correspondence with N specific points included in an operation area for sound characteristic adjustment, where N is a natural number greater than or equal to three, receiving an operation to specify, as a selected point, a freely selected location within the operation area, identifying, as a selected characteristic, a sound characteristic corresponding to the selected point, based on at least one specific point among the N specific points, at least one sound characteristic corresponding to the at least one specific point, and the selected point, determining that the selected characteristic is not to be a target sound characteristic that is set by the sound characteristic adjustment, in response to determining that the selected characteristic is not to be the target sound characteristic, executing, based on the selected characteristic and the N sound characteristics, updating processing to update at least one of the N sound characteristics to at least one sound characteristic other than the N sound characteristics, and in response to determining that the selected characteristic is not to be the target sound characteristic, receiving the operation again.

In another aspect, an audio adjustment apparatus includes at least one memory configured to store instructions, and at least one processor configured to execute the instructions to cause N sound characteristics to be in one-to-one correspondence with N specific points included in an operation area for sound characteristic adjustment, where Nis a natural number greater than or equal to three, receive an operation to specify, as a selected point, a freely selected location within the operation area, identify, as a selected characteristic, a sound characteristic corresponding to the selected point, based on at least one specific point among the N specific points, at least one sound characteristic corresponding to the at least one specific point, and the selected point, determine whether the selected characteristic is to be a target sound characteristic that is set by the sound characteristic adjustment, execute, in response to the selected characteristic not being determined to be the target sound characteristic, and based on the selected characteristic and the N sound characteristics, updating processing to update at least one of the N sound characteristics to at least one sound characteristic other than the N sound characteristics, and receive the operation again in response to the selected characteristic not being determined to be the target sound characteristic.

### BRIEF DESCRIPTION OF THE DRAWINGS

FIG. 1 is an explanatory diagram showing an audio adjustment apparatus according to an embodiment.

FIG. 2 is a diagram showing examples of an operation screen.

FIG. 3 is a diagram showing examples of the operation screen after execution of first updating processing.

FIG. 4 is a flowchart showing an example of an operation of the audio adjustment apparatus.

FIG. 5 is a diagram showing examples of an operation area according to a first modification.

### DETAILED DESCRIPTION

An embodiment according to this disclosure will now be described with reference to the accompanying drawings. In each drawing, dimensions and scales of elements may differ from those of actual products. The embodiment described below is an example of this disclosure, and includes various technical preferences. However, the scope of this disclosure is not limited to the embodiment described below unless a description is included that explicitly limits the scope of this disclosure.

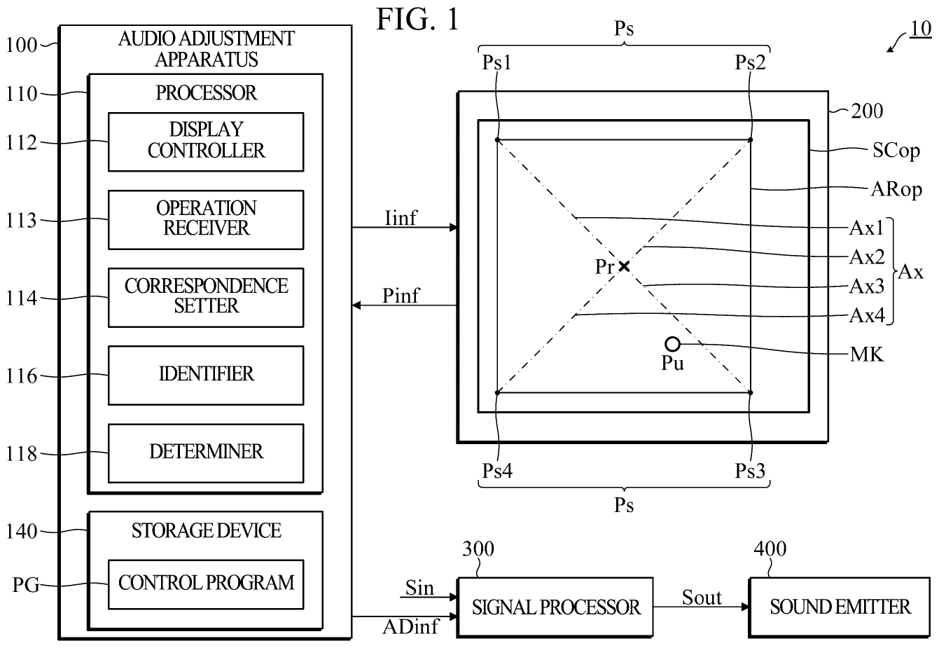

FIG. 1 is an explanatory diagram showing an audio adjustment apparatus 100 according to this embodiment.

In this embodiment, it is assumed that the audio adjustment apparatus 100, which is configured to adjust a sound characteristic, is included in an audio system 10. Examples of the sound characteristic include sound quality, and sound delay caused by a surround sound system, etc. Examples of the sound quality include a frequency characteristic, etc. The audio system 10 is a freely selected system that includes a signal processing function and a sound emitting function. Examples of the audio system 10 include one or more of types of systems such as a variety of types of audio systems, a karaoke system, a car stereo system, a public address (PA) system, or an electronic musical instrument. In this embodiment, it is assumed that the audio system 10 is an in-vehicle audio system.

The audio system 10 includes the audio adjustment apparatus 100, an input-output device 200, a signal processor 300, and a sound emitter 400, for example. First, the input-output device 200, the signal processor 300, and the sound emitter 400 will be briefly described before description of the audio adjustment apparatus 100.

The input-output device 200 is hardware (for example, a touch panel) in which an output device and an input device are paired, for example. The output device functions as a display for displaying a variety of types of information. The input device functions as an operation unit for receiving operations made by a user.

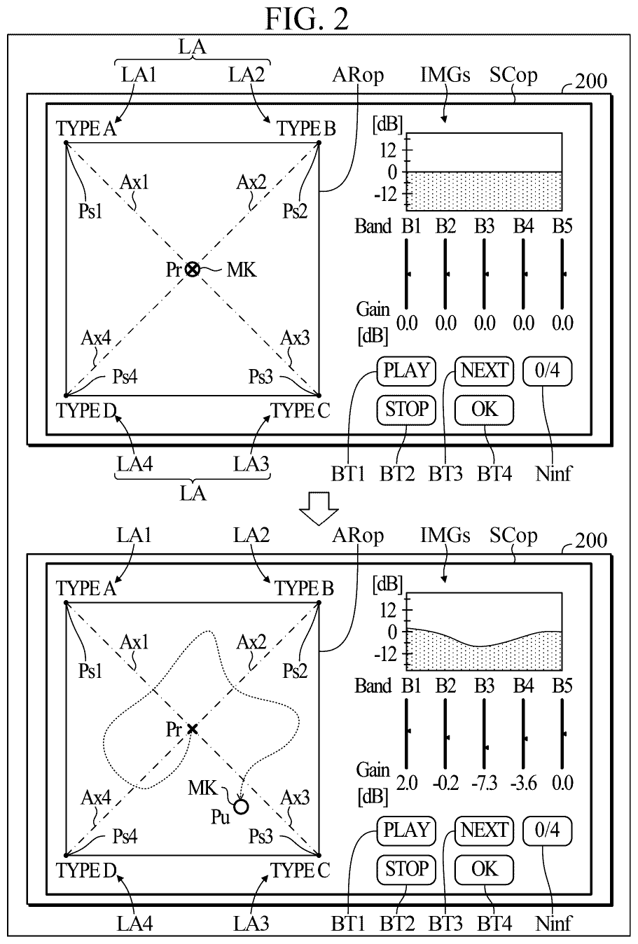

For example, the input-output device 200 displays a variety of types of information under the control of the audio adjustment apparatus 100 (more particularly, under the control of a display controller 112 described below). Specifically, the input-output device 200 displays an operation screen SCop based on image information Iinf provided by the audio adjustment apparatus 100. The operation screen SCop includes an operation image representing an operation area ARop for sound characteristic adjustment. In other words, the operation area ARop is displayed on the operation screen SCop. Details of the operation screen SCop are described below with reference to FIG. 2. The input-output device 200 is an example of a “display.”

As shown in FIG. 1, in this embodiment, it is assumed that the operation area ARop is a rectangle with four specific points Ps (Ps1, Ps2, Ps3, and Ps4) as vertices. A specific point Ps, which is any one of the four specific points Ps, is disposed at a location included in the operation area ARop. A correspondence setter 114 described below causes the location included in the operation area ARop to respond to a specific sound characteristic. The number of specific points Ps is not limited to four. For example, the number of specific points Ps may be three or may be five or more.

The input-output device 200 is configured to receive an operation made by the user and to provide the audio adjustment apparatus 100 with operation information Pinf indicative of content of the received user operation, for example. By way of example, when the operation made by the user is an operation to specify as a selected point Pu a freely selected location within the operation area ARop, the input-output device 200 provides the audio adjustment apparatus 100 with the operation information Pinf indicative of the selected point Pu specified by the user.

The operation information Pinf may indicate a location of the selected point Pu either by way of coordinates indicative of a location within a display screen of the input-output device 200 or by way of coordinates indicative of a location within the operation screen SCop, for example. Alternatively, the operation information Pinf may indicate the location of the selected point Pu within the operation area ARop. For example, the location of the selected point Pu within the operation area ARop is indicated by use of one or two axes Ax among four axes Ax1, Ax2, Ax3 and Ax4, which respectively extend from a reference point Pr within the operation area ARop to the four specific points Ps1, Ps2, Ps3, and Ps4. In this embodiment, it is assumed that a distance from the reference point Pr to a specific point Ps among the four specific points Ps is equal to a distance from the reference point Pr to each specific point Ps of three specific points Ps other than the specific point Ps among the four specific points Ps. However, a distance from the reference point Pr to a specific point Ps among the four specific points Ps need not necessarily be equal to a distance from the reference point Pr to each specific point Ps of the three specific points Ps other than the specific point Ps among the four specific points Ps as long as the reference point Pr is within the operation area ARop. Further, the axes Ax and the reference point Pr need not necessarily be displayed on the operation screen SCop.

In this embodiment, it is assumed that the output device and the input device are provided in combination with each other. However, the output device (for example, a display) and the input device (for example, an operation device) may be provided separate from each other.

The signal processor 300 executes signal processing on an audio signal Sin to generate an audio signal Sout. The audio signal Sin may be provided by an external audio player (not shown), for example. In this embodiment, the audio signal Sin has a plurality of frequency bands and it is assumed that the signal processing executed on the audio signal Sin is equalizing to adjust levels of the plurality of frequency bands of the audio signal Sin. However, the signal processing executed on the audio signal Sin is not limited to equalizing. The signal processor 300 executes the equalizing on the audio signal Sin based on adjustment information ADinf provided by the audio adjustment apparatus 100, for example. Thus, the audio signal Sout is generated based on the adjustment information ADinf. The sound emitter 400 emits sound represented by the audio signal Sout provided by the signal processor 300. In other words, sound having a sound characteristic adjusted based on the adjustment information ADinf is emitted from the sound emitter 400. The sound emitter 400 is, for example, a loudspeaker.

The adjustment information ADinf is information for achieving a sound characteristic desired by the user. The adjustment information ADinf is information on parameter values that relate to the sound characteristic. The parameters may be referred to as sound parameters. The sound parameters are, for example, parameters used in applying effects to the audio represented by the audio signal Sin. For example, gain (amplification amount) for the plurality of frequency bands of the audio signal Sin is set in accordance with the sound parameters. In this embodiment, the adjustment information ADinf indicates the gain for the plurality of frequency bands of the audio signal Sin. The audio adjustment apparatus 100 configured to generate the adjustment information ADinf will be described below.

The audio adjustment apparatus 100 is an information processing apparatus configured to adjust the values of the sound parameters. The audio adjustment apparatus 100 may be constituted of a freely selected information processing apparatus. For example, the audio adjustment apparatus 100 includes a processor 110 and a storage device 140. The processor 110 is configured to control each element of the audio adjustment apparatus 100. The storage device 140 stores a variety of types of information.

The storage device 140 includes both a volatile memory and a non-volatile memory, for example. Examples of the volatile memory include a random access memory (RAM) that functions as a work area for the processor 110. Examples of the non-volatile memory include an electrically erasable programmable read only memory (EEPROM) that stores a variety of types of information such as a control program PG. The storage device 140 may include either the volatile memory or the non-volatile memory. The storage device 140 may be detachable from the audio adjustment apparatus 100. Specifically, the storage device 140 may be a storage medium such as a memory card that is detachable from the audio adjustment apparatus 100.

The processor 110 is configured to control the entire audio adjustment apparatus 100, and includes one or more central processing units (CPUs). The one or more CPUs are included in examples of at least one processor. For example, the processor 110 executes the control program PG stored in the storage device 140 to function as the display controller 112, an operation receiver 113, the correspondence setter 114, an identifier 116, and a determiner 118. Thus, the audio adjustment apparatus 100 functions as an apparatus configured to determine the values of the sound parameters for achieving the sound characteristic desired by the user, for example. In other words, the audio adjustment apparatus 100 functions as an apparatus configured to adjust the sound characteristic. The control program PG may be provided by another apparatus via a network.

If the processor 110 includes a plurality of CPUs, one, some, or all of the functions of the processor 110 may be implemented by the plurality of CPUs cooperating with each other in accordance with a program such as the control program PG. The processor 110 may include other hardware such as a graphics processing unit (GPU), a digital signal processor (DSP), or a field programmable gate array (FPGA) in addition to the one or more CPUs, or in place of one, some, or all of the one or more CPUs. In this instance, one, some or all of the functions of the processor 110 may be implemented by the other hardware such as the DSP.

The display controller 112 causes the input-output device 200 to display the operation screen SCop for sound characteristic adjustment, for example. The display controller 112 generates the image information Iinf indicative of the operation screen SCop and provides the generated image information Iinf to the input-output device 200, for example. Thus, the operation screen SCop indicated by the image information Iinf is displayed on the display screen of the input-output device 200.

The operation receiver 113 receives an operation to specify as the selected point Pu a freely selected location within the operation area ARop represented on the operation screen Scop. Specifically, the operation receiver 113 receives the operation information Pinf, which has been provided by the input-output device 200 to the audio adjustment apparatus 100, as information indicative of the selected point Pu within the operation area ARop, the selected point Pu within the operation area ARop being specified by the user's operation. In the following, the operation to specify as the selected point Pu the freely selected location within the operation area ARop may be referred to as a “specifying operation for selected point Pu.” The specifying operation for selected point Pu may be an operation such that a mark MK (for example, a pointer), which indicates the selected point Pu and is displayed on the operation screen Scop, is moved by a finger that is brought into contact with the mark MK on the operation screen Scop and then released from the mark MK on the operation screen Scop (more specifically, from the mark MK) at the freely selected location within the operation area ARop, for example. Alternatively, the specifying operation for selected point Pu may be a mouse operation by which the mark MK, which indicates the selected point Pu, is moved by a mouse and then the freely selected location at which the mark MK is disposed within the operation area ARop is fixed as the selected point Pu.

The correspondence setter 114 causes N sound characteristics to be in one-to-one correspondence with N specific points Ps included in the operation area ARop, where Nis a natural number greater than or equal to three. In this embodiment, it is assumed that the number of specific points Ps is equal to four as described above. In other words, it is assumed that N is equal to four. Thus, the correspondence setter 114 causes the four specific points Ps1, Ps2, Ps3, and Ps4 included in the operation area ARop to be in one-to-one correspondence with four sound characteristics. Each of the four sound characteristics in one-to-one correspondence with the four specific points Ps1, Ps2, Ps3, and Ps4 is defined by a parameter set including the sound parameters, for example. In other words, in this embodiment, a sound characteristic is defined by a parameter set including the sound parameter. For example, when a first parameter set defines a different sound characteristic from a sound characteristic defined by a second parameter set, the first parameter set differs from the second parameter set by a value of at least one sound parameter among the sound parameters. In this embodiment, as described above, values of the sound parameters indicate gain for the plurality of frequency bands of the audio signal Sin.

The identifier 116 identifies as a selected characteristic a sound characteristic corresponding to the selected point Pu based on at least one specific point Ps among the four specific points Ps, at least one sound characteristic corresponding to the at least one specific point Ps, and the selected point Pu.

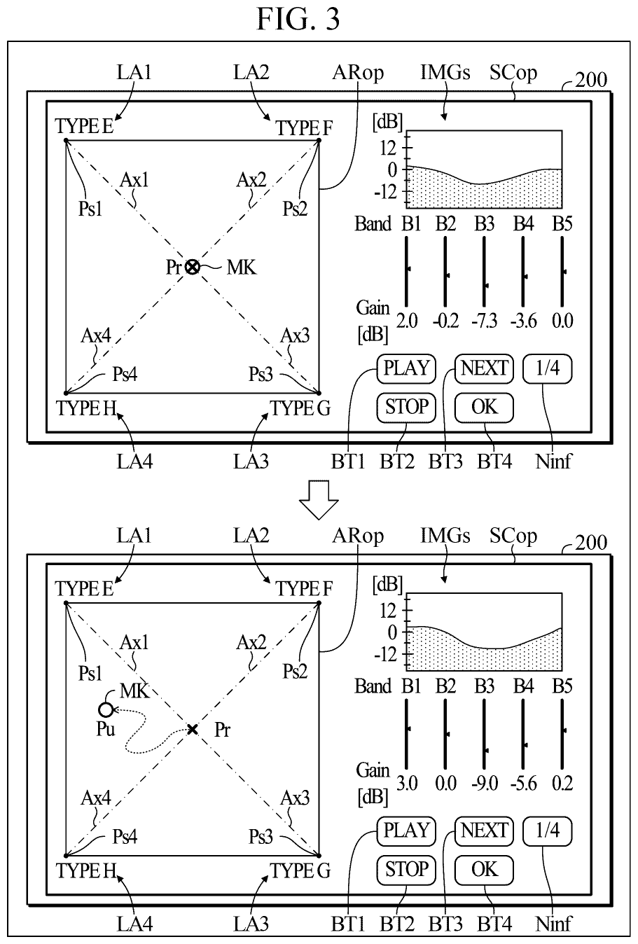

A sound characteristic corresponding to the reference point Pr may be an average of the four sound characteristics in one-to-one correspondence with the four specific points Ps. Alternatively, the sound characteristic corresponding to the reference point Pr may be a reference sound characteristic. The reference sound characteristic may be a flat frequency characteristic in which a gain for the plurality of frequency bands of the audio signal Sin is equal to 0 decibels, for example. Alternatively, when updating processing is executed by which at least one of the four sound characteristics in one-to-one correspondence with the four specific points Ps is updated, the reference sound characteristic may be constituted of the selected characteristic that is the sound characteristic corresponding to the selected point Pu. The updating processing is described below with reference to FIG. 3.

When a freely selected location within the operation area ARop differs from any of the locations of the four specific points Ps, and differs from the location of the reference point Pr, a sound characteristic (values of the sound parameters) corresponding to the freely selected location is identified by linearly interpolating two or three sound characteristics among five sound characteristics that are constituted of the four sound characteristics in one-to-one correspondence with the four specific points Ps and the sound characteristic corresponding to the reference point Pr, for example. Specifically, a sound characteristic corresponding to a freely selected location on the axis Ax1 is identified by linearly interpolating the sound characteristic corresponding to the reference point Pr and the sound characteristic corresponding to the specific point Ps1, for example. A sound characteristic corresponding to a freely selected location disposed between two axes Ax is identified by linearly interpolating three sound characteristics that are constituted of two sound characteristics in one-to-one correspondence with two specific points Ps corresponding to the two axes Ax and the sound characteristic corresponding to the reference point Pr, for example.

Thus, the identifier 116 identifies the sound characteristic corresponding to the selected point Pu by linearly interpolating three sound characteristics. The three sound characteristics are constituted of two sound characteristics in one-to one correspondence with two specific points Ps (the specific points Ps3 and Ps4 in an example shown in FIG. 1) close to the selected point Pu among the four specific points Ps, and the sound characteristic corresponding to the reference point Pr, for example. As described above, the identifier 116 identifies the sound characteristic corresponding to the selected point Pu as the selected characteristic based on three sound characteristics that are constituted of two sound characteristics in one-to one correspondence with two specific points Ps close to the selected point Pu among the four specific points Ps and the sound characteristic corresponding to the reference point Pr. A method for identifying the selected characteristic that is the sound characteristic corresponding to the selected point Pu is not limited to the method including linear interpolation and may be another technique such as a method that includes spline interpolation.

The determiner 118 determines whether the selected characteristic (sound characteristic corresponding to the selected point Pu) identified by the identifier 116 is to be a target sound characteristic that is set by the sound characteristic adjustment. The target sound characteristic is, for example, the sound characteristic desired by the user. In other words, the determiner 118 determines whether the selected characteristic identified by the identifier 116 is to be the sound characteristic desired by the user. Thus, the selected characteristic corresponds to a candidate for the target sound characteristic that is the sound characteristic desired by the user.

When the selected characteristic is determined not to be the target sound characteristic, the correspondence setter 114 executes, based on the selected characteristic and the four sound characteristics, the updating processing to update at least one of the four sound characteristics in one-to-one correspondence with the four specific points Ps to at least one sound characteristic other than the four sound characteristics. Then, the operation receiver 113 receives a new specifying operation for selected point Pu.

Thus, in this embodiment, the updating processing to update the four sound characteristics in one-to-one correspondence with the four specific points Ps and the specifying operation for selected point Pu are repeated until the selected characteristic is determined to be the target sound characteristic. In this embodiment, the selected point Pu is specified from the operation area ARop that is in association with the four sound characteristics. Thus, it is possible to determine the target sound characteristic efficiently compared to a configuration (hereinafter referred to as a “comparative example) in which the selected point Pu is specified by a slider that is associated with two sound characteristics. For example, compared to the comparative example, this embodiment can substantially prevent an increase in the number of times that the specifying operation for selected point Pu needs to be repeated until the selected characteristic is determined to be the target sound characteristic. Thus, the user can readily realize a desired sound characteristic by performing the specifying operation for selected point Pu several times.

A configuration of the audio system 10 is not limited the example shown in FIG. 1. In addition, a configuration of the audio adjustment apparatus 100 is not limited to the example shown in FIG. 1. For example, the operation area ARop need not necessarily be displayed by the input-output device 200, in which case the entire display screen of the input-output device 200 may act as the operation area ARop. As a further example, a diagram showing the operation area ARop need not necessarily be displayed. For example, portions of the operation screen SCop (or portions of the display screen of the input-output device 200), which are in one-to-one correspondence with the N specific points Ps, may be turned on. The audio adjustment apparatus 100 may include one of, or both of, the signal processor 300 and the input-output device 200, and may include one of, or both of, a display and an operating device.

Examples of the operation screen SCop will be described with reference to FIG. 2 and FIG. 3.

FIG. 2 is a diagram showing examples of the operation screen Scop. The upper part of FIG. 2 shows a default state of the operation screen SCop for sound characteristic adjustment. The lower part of FIG. 2 shows a state of the operation screen Scop in a case in which a first specifying operation for selected point Pu is performed (before a first determination of selected point Pu).

On the operation screen Scop, the operation area ARop and four labels LA (LA1, LA2, LA3 and LA4) representing the four sound characteristics are displayed, for example. The four labels LA (LA1, LA2, LA3 and LA4) are in one-to-one correspondence with the four specific points Ps (Ps1, Ps2, Ps3 and Ps4). A label LA, which is any one of the four labels LA, enables the user who views the label to understand a sound characteristic corresponding to the label. The label may be, for example, a word for a sense, a diagram, or a color. The label LA can be updated in accordance with updating of a sound characteristic that corresponds to the label LA. Each of the operation screens SCop shown in FIG. 2 represents a plurality of buttons BT (BT1, BT2, BT3, and BT4 for a graphical user interface (GUI), information Ninf indicative of the number of times that the updating processing is executed, and an image IMGs for confirming a sound characteristic. Touching any one of the buttons BT, may also include pressing any one of the buttons BT.

In the example shown in FIG. 2, in the image IMGs five sound parameters for setting gain for five frequency bands constituted of a band B1, a band B2, a band B3, a band B4, and a band B5 are included in a parameter set of each of the five sound characteristics that are constituted of the four sound characteristics in one-to-one correspondence with the four specific points Ps, and the sound characteristic corresponding to the reference point Pr.

As shown in the upper part of FIG. 2, a default sound characteristic corresponding to the reference point Pr is a flat frequency characteristic in which a gain for the five frequency bands constituted of the band B1, the band B2, the band B3, the band B4, and the band B5 is equal to 0 decibels.

In the default state before sound characteristic adjustment, four sound characteristics prepared in advance are in one-to-one correspondence with the four specific points Ps, for example. For example, four typical sound characteristics that are set by a manufacturer are prepared in advance as four sound characteristics to be in one-to-one correspondence with the four specific points Ps in the default state. For example, a characteristic (“TYPE A” shown in FIG. 2) represented by the label LA1 denotes a default sound characteristic corresponding to the specific point Ps1. A characteristic (“TYPE B” shown in FIG. 2) represented by the label LA2 denotes a default sound characteristic corresponding to the specific point Ps2. A characteristic (“TYPE C” shown in FIG. 2) represented by the label LA3 denotes a default sound characteristic corresponding to the specific point Ps3. A characteristic (“TYPE D” shown in FIG. 2) represented by the label LA4 denotes a default sound characteristic corresponding to the specific point Ps4.

In the default state before sound characteristic adjustment, the mark MK indicative of the selected point Pu is disposed at the reference point Pr. For example, the user performs, as the specifying operation for selected point Pu, an operation by which the mark MK is moved by the user's finger being brought into contact with the mark MK and the finger then being released from the operation screen Scop (more specifically, from the mark MK) at a freely selected location within the operation area ARop. The dotted arrow track shown in the operation screen SCop of the lower part of FIG. 2 is an example of a track of the mark MK moved during the specifying operation for selected point Pu.

For example, when the button BT1 is touched, the sound emitter 400 emits sound with a sound characteristic corresponding to a location of the mark MK. When the button BT2 is touched, the sound emitter 400 stops the emission of the sound. The sound emitter 400 may continue the emission of the sound until an end of the sound without stopping the emission of the sound. The buttons BT1 and BT2 may be constituted of a button BT for controlling playing and stopping executed by the external audio player, for example. Alternatively, the buttons BT1 and BT2 may be constituted of a button BT for controlling turning output of the sound emitter 400 on and off. A GUI (for example, the buttons BT1 and BT2) for controlling playing etc., executed by the external audio player need not necessarily be represented on the operation screen Scop. In other words, the external audio player need not necessarily be controlled via the GUI. In this instance, a configuration may be applied in which the above-described processing is only executed on an input audio signal (for example, the audio signal Sin). When the button BT3 is touched, a location of the mark MK at a point in time at which the button BT3 is touched is identified as the selected point Pu and then the updating processing is executed to update at least one of the four sound characteristics in one-to-one correspondence with the four specific points Ps to at least one sound characteristic other than the four sound characteristics. When the button BT3 is touched in a state in which the number of times that the updating processing is executed is equal to an upper limit (four times in the example shown in FIG. 2), a sound characteristic (selected characteristic) corresponding to a location (selected point Pu) of the mark MK at a point in time at which the button BT3 is touched may be determined to be the target sound characteristic. When the button BT4 is touched, a sound characteristic (selected characteristic) corresponding to a location (selected point Pu) of the mark MK at a point in time at which the button BT4 is touched is determined to be the target sound characteristic.

For example, when the user performs the specifying operation for selected point Pu after touching the button BT1, the user can specify the selected point Pu while listening to sound with a sound characteristic corresponding to a location of the mark MK that is moved. This allows the user to search the operation area ARop for a desired sound characteristic. In FIG. 2, it is assumed that the button BT3 is touched in a case in which the operation screen SCop is in the state shown in the lower part of FIG. 2. Thus, in FIG. 2, a sound characteristic, in which a gain for the band B1, a gain for the band B2, a gain for the band B3, a gain for the band B4, and a gain for the band B5 are 2.0 dB, −0.2 dB, −7.3 dB, −3.6 dB, and 0.0 dB, respectively, is identified as a first selected characteristic. An m-th selected characteristic is a sound characteristic corresponding to a selected point Pu specified by an m-th specifying operation for selected point Pu, where m is a natural number greater than or equal to one.

Next, examples of the operation screen SCop after identification of the first selected characteristic will be described with reference to FIG. 3. In other words, examples of the operation screen SCop after execution of a first updating processing will be described with reference to FIG. 3.

FIG. 3 is a diagram showing examples of the operation screen SCop after the execution of the first updating processing. The upper part of FIG. 3 shows a state of the operation screen SCop after the execution of the first updating processing. The lower part of FIG. 3 shows a state of the operation screen Scop in a case in which a second specifying operation for selected point Pu is performed (before a second determination of selected point Pu).

For example, the first updating processing is executed based on the sound characteristic (the first selected characteristic) corresponding to the selected point Pu specified by the first specifying operation for selected point Pu, four default sound characteristics in one-to-one correspondence with the four specific points Ps, and a default sound characteristic corresponding to the reference point Pr. For example, a characteristic (“TYPE E” shown in FIG. 3) represented by the label LA1 denotes a sound characteristic corresponding to the specific point Ps1 in a state in which the first updating processing is completed. A characteristic (“TYPE F” shown in FIG. 3) represented by the label LA2 denotes a sound characteristic corresponding to the specific point Ps2 in the state in which the first updating processing is completed. A characteristic (“TYPE G” shown in FIG. 3) represented by the label LA3 denotes a sound characteristic corresponding to the specific point Ps3 in the state in which the first updating processing is completed. A characteristic (“TYPE H” shown in FIG. 3) represented by the label LA4 denotes a sound characteristic corresponding to the specific point Ps4 in the state in which the first updating processing is completed.

For example, the updating processing to update sound characteristics in one-to-one correspondence with the specific points Ps may be executed by use of Bayesian optimization as a method for estimating a point at which an optimal solution is likely to be obtained. When Bayesian optimization is used, the sound characteristics in one-to-one correspondence with the specific points Ps are updated taking into account both a sound characteristic by which the target sound characteristic is likely to be obtained and sound characteristics that have not yet been explored. The sound characteristic by which the target sound characteristic is likely to be obtained is identified based on a preferred parameter set (a sound characteristic corresponding to the selected point Pu) and five non-preferred parameter sets (five sound characteristics constituted of four sound characteristics in one-to-one correspondence with the four specific points Ps and the sound characteristic corresponding to the reference point Pr).

When a distance between the selected point Pu and a point among five points constituted of the four specific points Ps and the reference point Pr is less than or equal to a threshold, a parameter set corresponding to the point among the five points may be removed from the five non-preferred parameter sets.

The preferred parameter set and the five non-preferred parameter sets may be stored in the storage device 140 each time the specifying operation of selected point Pu is performed (each time the selected characteristic is identified), for example. In this instance, the preferred parameter set and the non-preferred parameter sets are accumulated each time the specifying operation of selected point Pu is performed. The sound characteristic by which the target sound characteristic is likely to be obtained may be identified based on the accumulated parameter sets constituted of one or more preferred parameter sets and five or more non-preferred parameter sets. In other words, when the updating processing is executed two or more times, the second updating processing and the subsequent updating processing may be executed based further on the selected characteristic and four sound characteristics used in the previous updating processing.

When the first updating processing is completed, as shown the upper part of FIG. 3, an initial location of the mark MK indicative of the selected point Pu on the operation screen SCop is the same as the location of the reference point Pr, for example. After the first updating processing is completed, the reference point Pr is caused to correspond to the sound characteristic (the first selected characteristic) corresponding to the selected point Pu specified by the first specifying operation for selected point Pu.

For example, as in the first specifying operation for selected point Pu, when the user performs a specifying operation for selected point Pu after touching the button BT1, the user can specify the selected point Pu while listening to sound with a sound characteristic corresponding to a location to which the mark MK is moved. The dotted arrow track in the operation screen SCop shown in the lower part of FIG. 3 is an example of a track of the mark MK moved during the specifying operation for selected point Pu.

When the button BT3 is touched in a case in which the operation screen SCop is in a state shown in the lower part of FIG. 3, a second updating processing is executed. When the button BT4 is touched in the case in which the operation screen SCop is in the state shown in the lower part of FIG. 3, a sound characteristic (selected characteristic) corresponding to a location (selected point Pu) of the mark MK at a point in time at which the button BT4 is touched is determined to be the target sound characteristic.

As described above, in this embodiment, the updating processing to update the sound characteristics in one-to-one correspondence with the specific points Ps is executed based on a desired sound characteristic (selected characteristic) selected by the user through the specifying operation for selected point Pu. Thus, in this embodiment, it is possible to propose a new operation area ARop to the user based on the desired sound characteristic selected by the user. Consequently, in this embodiment, it is possible to readily achieve the target sound characteristic through a repetition of the specifying operation for selected point Pu and a repetition of the updating processing. In the examples shown in FIG. 2 and FIG. 3, the upper limit of the number of times that the updating processing is executed is set in advance. However, the upper limit of the number of times that the updating processing is executed may not be set.

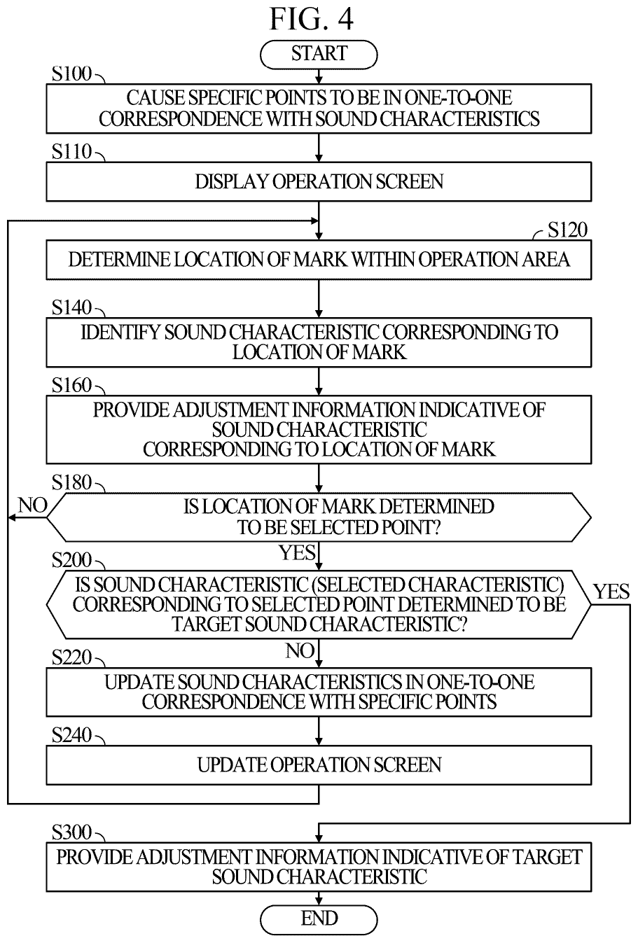

An example of an operation of the audio adjustment apparatus 100 will now be described with reference to FIG. 4.

FIG. 4 is a flowchart showing an example of an operation of the audio adjustment apparatus 100. After an operation to start sound characteristic adjustment is performed, processing is executed at step S100, for example.

At step S100, the processor 110 functions as the correspondence setter 114 and causes the four specific points Ps within the operation area ARop to be in one-to-one correspondence with four sound characteristics.

At step S110, the processor 110 functions as the display controller 112 and causes the input-output device 200 to display the operation screen SCop. For example, the display controller 112 provides the input-output device 200 with the image information Iinf indicative of the operation screen SCop to cause the input-output device 200 to display the operation screen SCop.

At step S120, the processor 110 functions as the operation receiver 113 and determines a location of the mark MK indicative of the selected point Pu within the operation area ARop. For example, the operation receiver 113 acquires the operation information Pinf indicative of the location of the mark MK from the input-output device 200 and determines the location of the mark MK based on the operation information Pinf. As described above, at step S120, the operation receiver 113 receives an operation to specify as the selected point Pu a freely selected location within the operation area ARop.

At step S140, the processor 110 functions as the identifier 116 and identifies a sound characteristic corresponding to the location of the mark MK. For example, the identifier 116 identifies a value of each of the sound parameters included in the parameter set for the sound characteristic corresponding to the location of the mark MK by linearly interpolating two or three sound characteristics among the five sound characteristics that are constituted of the four sound characteristics in one-to-one correspondence with the four specific points Ps and the sound characteristic corresponding to the reference point Pr.

At step S160, the processor 110 functions as the identifier 116 and provides the signal processor 300 with adjustment information ADinf indicative of the sound characteristic (the values of the sound parameters) corresponding to the location of the mark MK. Thus, the signal processor 300 generates an audio signal Sout based on the adjustment information ADinf. The sound emitter 400 emits sound indicated by the audio signal Sout. In other words, the sound with the characteristic corresponding to the location of the mark MK is emitted by the sound emitter 400.

At step S180, the processor 110 functions as the operation receiver 113 and determines whether the location of the mark MK is to be the selected point Pu. For example, when the button BT3 or the button BT4 is touched, the operation receiver 113 determines that the location of the mark MK is determined to be the selected point Pu.

When the determination at step S180 is affirmative, the operation receiver 113 determines the location of the mark MK to be the selected point Pu and moves the processing to step S200. For example, when the button BT3 or the button BT4 is touched, the operation receiver 113 determines the location of the mark MK at a point in time at which the button BT (the button BT3 or the button BT4) is touched to be the selected point Pu and moves the processing to step S200. In this instance, a sound characteristic corresponding to the location of the mark MK at the point in time at which the button BT3 or the button BT4 is touched is the sound characteristic (selected characteristic) corresponding to the selected point Pu.

On the other hand, when the determination at step S180 is negative, the operation receiver 113 returns the processing to step S120.

At step S200, the processor 110 functions as the determiner 118 and determines whether the sound characteristic (selected characteristic) corresponding to the selected point Pu is to be the target sound characteristic. For example, when the button BT4 is touched, the determiner 118 determines that the selected characteristic is to be the target sound characteristic. When the button BT3 is touched in a state in which the number of times that the updating processing is executed is equal to the upper limit, the determiner 118 determines that the selected characteristic is to be the target sound characteristic. When the button BT3 is touched in a state in which the number of times that the updating processing is executed is less than the upper limit, the determiner 118 determines that the selected characteristic is not to be the target sound characteristic.

When the determination at step S200 is affirmative, the determiner 118 determines the selected characteristic to be the target sound characteristic and moves the processing to step S300. For example, when the button BT4 is touched, the determiner 118 determines the sound characteristic (selected characteristic) corresponding to the location (selected point Pu) of the mark MK at the point in time at which the button BT4 is touched to be the target sound characteristic and moves the processing to step S300.

On the other hand, when the determination at step S200 is negative, the determiner 118 determines the selected characteristic and moves the processing to step S220. For example, when the button BT3 is touched in a state in which the number of times that the updating processing is executed is less than the upper limit, the determiner 118 determines the sound characteristic corresponding to the location (selected point Pu) of the mark MK at the point in time at which the button BT3 is touched to be the selected characteristic and moves the processing to step S220.

At step S220, the processor 110 functions as the correspondence setter 114 and updates the four sound characteristics in one-to-one correspondence with the four specific points Ps within the operation area ARop. For example, as described with reference to FIG. 3, the correspondence setter 114 uses Bayesian optimization to execute the updating processing to update the four sound characteristics in one-to-one correspondence with the four specific points Ps within the operation area ARop. Although not shown in FIG. 4, at step S220, the correspondence setter 114 causes the sound characteristic (selected characteristic) corresponding to the selected point Pu to correspond to the reference point Pr. After execution of the processing at step S220, the correspondence setter 114 moves the processing to step S240.

At step S240, the processor 110 functions as the display controller 112 and updates the operation screen SCop. For example, the display controller 112 provides image information Iinf indicative of an updated operation screen SCop to the input-output device 200. After execution of the processing at step S240, the display controller 112 returns the processing to step S120. Thus, when the selected characteristic is determined not to be the target sound characteristic, the updating processing is executed, and another specifying operation for selected point Pu is received. When the selected characteristic is determined to be the target sound characteristic, the processing is executed at step S300 as described above.

At step S300, the processor 110 functions as the identifier 116, for example, and provides adjustment information ADinf indicative of the target sound characteristic (value of each of the sound parameters) to the signal processor 300. The processing at step S300 may be executed by another functional block other than the identifier 116 (for example, the determiner 118).

Thus, in this embodiment, when the selected characteristic is determined not to be the target sound characteristic, the updating processing is executed based on the selected characteristic etc. As a result, at least one of the four sound characteristics in one-to-one correspondence with the four specific points Ps is updated. In this embodiment, when the updating processing is executed once, four sound characteristics can be updated. Thus, it is possible to more efficiently determine the target sound characteristic compared to a configuration in which when the updating processing is executed once, two sound characteristics can be updated. Consequently, in this embodiment, the user can readily realize a desired sound characteristic by performing the specifying operation for selected point Pu several times, for example.

The updating of the operation area ARop by the updating processing (updating of the at least one of the four sound characteristics in one-to-one correspondence with the four specific points Ps) may be understood as a suggestion to the user of at least one new evaluation axis. Thus, in this embodiment, since a new evaluation axis is suggested to the user in accordance with values of the sound parameters selected by the user, the user is able to find a new preferred sound by sound characteristic adjustment.

The operation of the audio adjustment apparatus 100 is not limited to the example shown in FIG. 4. For example, the processing at step S100 may be executed before the operation to start the sound characteristic adjustment is performed.

In this embodiment, the audio adjustment apparatus 100 includes the correspondence setter 114, the operation receiver 113, the identifier 116, and the determiner 118. The correspondence setter 114 causes N sound characteristics to be in one-to-one correspondence with the N specific points Ps included in the operation area ARop for sound characteristic adjustment, where N is a natural number greater than or equal to three. The operation receiver 113 receives an operation (specifying operation for selected point Pu) to specify, as a selected point Pu, a freely selected location within the operation area ARop. The identifier 116 identifies, as a selected characteristic, a sound characteristic corresponding to the selected point Pu, based on at least one specific point Ps among the N specific points Ps, at least one sound characteristic corresponding to the at least one specific point Ps, and the selected point Pu. The determiner 118 determines whether the selected characteristic is to be a target sound characteristic that is set by the sound characteristic adjustment. When the selected characteristic is determined not to be the target sound characteristic, the correspondence setter 114 executes updating processing to update at least one sound characteristic of the N sound characteristics to at least one sound characteristic other than the N sound characteristics based on the selected characteristic and the N sound characteristics, and the operation receiver 113 receives the operation (specifying operation for selected point Pu) again.

Thus, in this embodiment, the updating processing to update the N sound characteristics in one-to-one correspondence with the N specific points Ps, and the specifying operation for selected point Pu are repeated until the selected characteristic is determined to be the target sound characteristic. In this embodiment, when the updating processing is executed once, N sound characteristics can be updated. Thus, it is possible to more efficiently determine the target sound characteristic compared to a configuration in which when the updating processing is executed once, only two sound characteristics can be updated. An example of a state in which when the updating processing is executed once and only two sound characteristics can be updated is a state in which the selected point Pu is specified by a slider that is in association with two sound characteristics. For example, in this embodiment, compared to the configuration in which only two sound characteristics can be updated when the updating processing is executed once, it is possible to reduce the number of times that the user preforms the specifying operation for selected point Pu until completion of a desired sound characteristic.

In this embodiment, the identifier 116 identifies the selected characteristic based further on a sound characteristic corresponding to the reference point Pr within the operation area ARop. Thus, in this embodiment, compared to a configuration in which the selected characteristic is identified not based on the sound characteristic corresponding to the reference point Pr, it is possible to more readily identify the selected characteristic. In this embodiment, the updating processing may further be executed based on the sound characteristic corresponding to the reference point Pr. In this instance, compared to a configuration in which the updating processing is executed not based on the sound characteristic corresponding to the reference point Pr, it is possible to more efficiently determine a parameter set for a sound characteristic that is to be caused to correspond to a specific point Ps in the updating processing.

In this embodiment, a distance from the reference point Pr to a specific point Ps among the N specific points Ps is equal to a distance from the reference point Pr to each specific point Ps of specific points Ps other than the specific point Ps among the N specific points Ps. In this instance, compared to a configuration in which a distance from the reference point Pr to a specific point Ps among the N specific points Ps is not equal to a distance from the reference point Pr to each specific point Ps of specific points Ps other than the specific point Ps among the N specific points Ps, it is possible to more readily identify the selected characteristic. When a distance from the reference point Pr to a specific point Ps among the N specific points Ps is equal to a distance from the reference point Pr to each specific point Ps of specific points Ps other than the specific point Ps among the N specific points Ps, it is possible to more efficiently determine a parameter set for a sound characteristic that is to be caused to correspond to a specific point Ps in the updating processing compared to a configuration in which a distance from the reference point Pr to a specific point Ps among the N specific points Ps is not equal to a distance from the reference point Pr to each specific point Ps of specific points Ps other than the specific point Ps among the N specific points Ps.

In this embodiment, the operation area ARop is a polygon with the N specific points Ps as vertices. In this instance, compared to a configuration in which the specific points Ps exist inside a boundary (an outer edge) of the operation area ARop, it is possible to substantially avoid complication in identifying of the selected characteristic.

In this embodiment, the N specific points Ps are four specific points Ps. In other words, in this embodiment, the operation area ARop is a rectangle with the four specific points Ps as vertices. Compared to a configuration in which the operation area ARop is a triangle, a polygon, or a shape with more than five sides, complexity for a user to identify the selected characteristic can be substantially reduced.

In this embodiment, the correspondence setter 114 causes the selected characteristic to correspond to the reference point Pr in the updating processing. Thus, in this embodiment, the reference point Pr within the operation area ARop after execution of the updating processing is caused to correspond to the sound characteristic (selected characteristic) corresponding to the selected point Pu specified by the specifying operation for selected point Pu before the execution of the updating processing. In other words, in this embodiment, the operation area ARop can be updated such that the sound characteristic corresponding to the reference point Pr within the operation area ARop is a sound characteristic close to the sound characteristic desired by the user. As a result, in this embodiment, compared to a configuration in which a location corresponding to the selected characteristic before the execution of the updating processing is not within the operation area ARop after the execution of the updating processing, it is possible to substantially prevent an increase in the number of times that the updating processing to update the N specific points Ps is executed.

In this embodiment, in the updating processing to update at least one sound characteristic of the N sound characteristics to at least one sound characteristic other than the N sound characteristics, the correspondence setter 114 determines the at least one sound characteristic other than the N sound characteristics based on the selected characteristic, the N sound characteristics, and the sound characteristic corresponding to the reference point Pr. In other words, the updating processing includes processing to cause the at least one sound characteristic other than the N sound characteristics to be determined based on the selected characteristic, the N sound characteristics, and the sound characteristic corresponding to the reference point Pr. As described above, in this embodiment, based on the sound characteristic corresponding to the reference point Pr in addition to both the selected characteristic and the N sound characteristics, the N sound characteristics are determined that are to be in one-to-one correspondence with the N specific points Ps included in the operation area ARop after the execution of the updating processing. Thus, in this embodiment, compared to a configuration in which the sound characteristic corresponding to the reference point Pr is not used in the updating processing, it is possible to increase a probability that a location corresponding to a sound characteristic close to a sound characteristic desired by the user will be within the operation area ARop after the execution of the updating processing.

In this embodiment, when the correspondence setter 114 executes the updating processing two or more times, the correspondence setter 114 executes the second updating processing and the subsequent updating processing based further on the selected characteristic and the N sound characteristics used in the previous updating processing. As described above, in this embodiment, when the updating processing is executed two or more times, the second and subsequent updating processing are executed further based on information about the previous updating processing (the selected characteristic and the N sound characteristics used in the previous updating processing). Thus, in this embodiment, compared to a configuration in which the second and subsequent updating processing are executed not based on the information about the previous updating processing, it is possible to increase a probability that a location corresponding to a sound characteristic close to a sound characteristic desired by the user will be within the operation area ARop after the execution of the updating processing.

In this embodiment, the audio adjustment apparatus 100 includes the display controller 112. The display controller 112 causes the input-output device 200 to display N labels LA denoting the N sound characteristics such that the N labels LA are in one-to-one correspondence with the N specific points Ps. As described above, in this embodiment, the N labels LA denoting the N sound characteristics corresponding to the N specific points Ps are displayed such that the N labels LA are in one-to-one correspondence with the N specific points Ps. Thus, in this embodiment, the user can readily understand the N sound characteristics corresponding to the N specific points Ps within the operation area ARop. Consequently, it is possible to facilitate an operation (for example, a specifying operation for selected point Pu) to search for a sound characteristic desired by the user.

The embodiment described above can be variously modified. The following are examples of modifications of the embodiment described above. Two or more modifications freely selected from the following modifications may be combined as long as no conflict arises from such a combination.

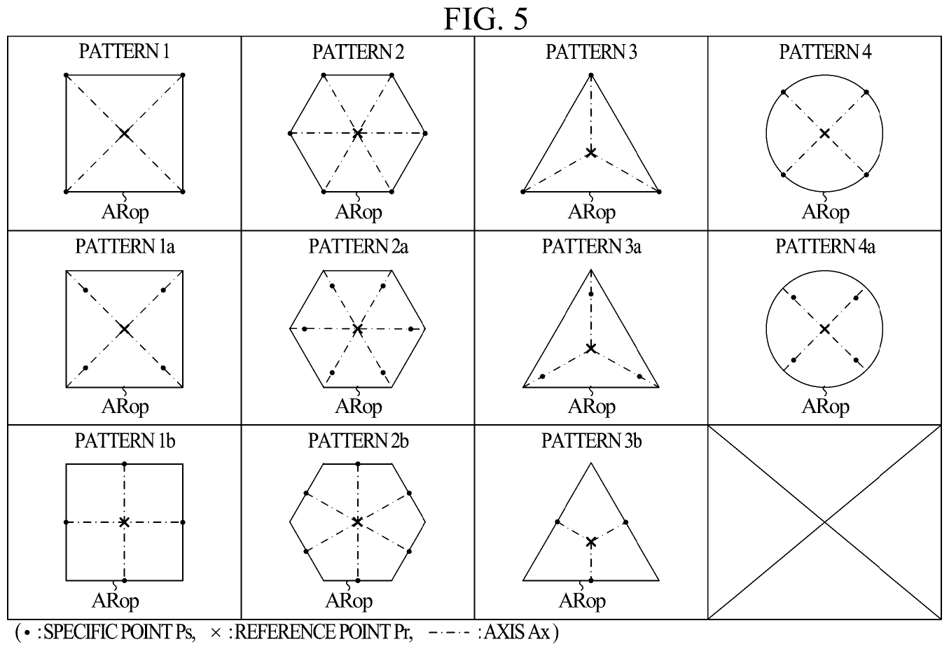

In the above-described embodiment, an example is described in which the operation area ARop is a rectangle with the four specific points Ps as vertices. However, this disclosure is not limited thereto. For example, the operation area ARop may be a triangle, or a pentagon, or a shape with more sides than a pentagon, or may be a circle. This modification (first modification) will be described with reference to FIG. 5.

FIG. 5 is an explanatory diagram showing examples of the operation area ARop according to the first modification. In FIG. 5, black dots denote specific points Ps, marks “×” denote reference points Pr, and dashed-and-dotted lines denote axes Ax. In FIG. 5, the operation area ARop according to the embodiment described above is shown as a pattern 1.

In FIG. 5, the pattern 1, a pattern 1a, and a pattern 1b are examples of an operation area ARop that is a rectangle. In FIG. 5, a pattern 2, a pattern 2a, and a pattern 2b are examples of an operation area ARop that is a hexagon. In FIG. 5, a pattern 3, a pattern 3a, and a pattern 3b are examples of an operation area ARop that is triangle. In FIG. 5, a pattern 4 and a pattern 4a are examples of an operation area ARop that is a circle.

The pattern 1, the pattern 2, and the pattern 3 are examples of an operation area ARop that is a polygon with specific points Ps as vertices. The pattern 4 is an example of an operation area ARop that is a circle with a boundary (outer edge) on which specific points Ps are disposed. The pattern 1a, the pattern 2a, the pattern 3a, and the pattern 4a are examples of an operation area ARop that has a boundary (outer edge) inside which specific points Ps are disposed. The pattern 1b, the pattern 2b, and the pattern 3b are examples of an operation area ARop that is a polygon each of the sides of which has a midpoint at which a specific point Ps is disposed.

In each of the operation areas ARop shown in FIG. 5, a distance from a reference point Pr to a specific point Ps among specific points Ps is equal to a distance from the reference point Pr to each specific point Ps of specific points Ps other than the specific point Ps. However, a distance from the reference point Pr to a specific point Ps among specific points Ps need not necessarily be equal to a distance from the reference point Pr to each specific point Ps of specific points Ps other than the specific point Ps.

As described above, the operation area ARop may be other than a rectangle with four specific points Ps as vertices.

This modification provides the same effects as those provided by the above-described embodiment. For example, when the number of specific points Ps within the operation area ARop is large, compared to a configuration in which the number of specific points Ps within the operation area ARop is small, it is possible to reduce the number of times that a specifying operation for selected point Pu is performed until a target sound characteristic is realized.

In the above-described embodiment and in the above-described modification, an example is described in which the sound characteristic to be adjusted is gain for each of the plurality of frequency bands. However, this disclosure is not limited thereto.

For example, in this modification (second modification), the sound characteristic to be adjusted may be a sound characteristic other than gain for each of the plurality of frequency bands or may be a combination of gain for each of the plurality of frequency bands and a sound characteristic other than gain. Specifically, the sound characteristic to be adjusted may be one or more of: gain for each of the plurality frequency bands, a frequency, a bandwidth of each of the plurality of frequency bands (so-called Q width), delay caused by a surround sound system, and a volume balance in the surround sound system (for example, gain per speaker). Alternatively, the sound characteristic to be adjusted may be one or more of: effect intensity indicative of a degree of effect of correction of a high frequency band, effect intensity indicative of a degree of effect of correction of a low frequency band, and effect intensity indicative of a degree of sound effect on a surround sound system. The sound characteristic to be adjusted may be a combination of gain, frequency, Q width, delay, volume balance, and the multiple effect intensities referred to above.

This modification provides the same effects as those provided by the above-described embodiment or by the above-described modification.

In the above-described embodiment and in the above-described modifications, an example is described in which the audio system 10 is an in-vehicle audio system. In other words, an example is described in which the audio adjustment apparatus 100 is used to adjust a sound characteristic of an in-vehicle audio system. However, this disclosure is not limited to thereto.

For example, in this modification (third modification), the audio adjustment apparatus 100 may be used to adjust a sound characteristic of an audio system other than an in-vehicle audio system. Specifically, the audio adjustment apparatus 100 may be used to adjust a sound characteristic of earphones or may be used to adjust a sound characteristic of a sound bar, for example. The audio adjustment apparatus 100 may be used to adjust a sound characteristic of a synthesizer or may be used to adjust a sound characteristic of a digital piano, for example. In other words, the audio adjustment apparatus 100 may be used to adjust a sound characteristic of an electronic musical instrument. In this modification, the audio adjustment apparatus 100 may be a terminal device such as a smartphone configured to execute the control program PG shown in FIG. 1, or may be an information processing apparatus such as a personal computer configured to execute the control program PG.

This modification provides the same effects as those provided by the above-described embodiment or by the above-described modifications.

In the above-described embodiment and in the above-described modifications, an example is described in which the selected characteristic is identified further based on a sound characteristic corresponding to the reference point Pr within the operation area ARop. However, this disclosure is not limited thereto.

For example, in this modification (fourth modification), the sound characteristic corresponding to the reference point Pr within the operation area ARop may be an average of the N sound characteristics in one-to-one correspondence with the N specific points Ps. In this instance, when a sound characteristic is not caused to correspond to the reference point Pr in advance, the sound characteristic corresponding to the reference point Pr can be readily identified based on the N sound characteristics. Thus, when the average of the N sound characteristics in one-to-one correspondence with the N specific points Ps is the sound characteristic corresponding to the reference point Pr, the selected characteristic may be identified based on the N sound characteristics in one-to-one correspondence with the N specific points Ps not based on the sound characteristic corresponding to the reference point Pr. When the sound characteristic corresponding to the reference point Pr is a flat frequency characteristic in which a gain for each of the plurality of frequency bands is equal to 0 decibels, the selected characteristic may be identified not based on the sound characteristic corresponding to the reference point Pr.

Except for effects provided by processing in which the selected characteristic is identified further based on the sound characteristic corresponding to the reference point Pr, this modification provides the same effects as those provided by the above-described embodiment or by the above-described modifications.

In the above-described embodiment and in the above-described modifications, an example is described in which the updating processing causes the selected characteristic to correspond to the reference point Pr. However, this disclosure is not limited thereto.

For example, in this modification (fifth modification), when the updating processing is executed, the sound characteristic corresponding to the reference point Pr may be the average of the N sound characteristics in one-to-one correspondence with the N specific points Ps. Alternatively, for example, the sound characteristic corresponding to the reference point Pr may be fixed at a flat frequency characteristic in which a gain for each of the frequency bands is equal to 0 decibels.

Except for effects provided by the updating processing that causes the selected characteristic to correspond to the reference point Pr, this modification provides the same effects as those provided by the above-described embodiment or by the above-described modifications.

In the above-described embodiment and in the above-described modifications, an example is described in which the updating processing is executed based on the selected characteristic, the N sound characteristics, and the sound characteristic corresponding to the reference point Pr. However, this disclosure is not limited thereto.

For example, in this modification (sixth modification), when the average of the N sound characteristics in one-to-one correspondence with the N specific points Ps is the sound characteristic corresponding to the reference point Pr, the updating processing may be executed not based on the sound characteristic corresponding to the reference point Pr. Alternatively, for example, when the sound characteristic corresponding to the reference point Pr is a flat frequency characteristic in which a gain for each of the frequency bands is equal to 0 decibels, the updating processing may be executed not based on the sound characteristic corresponding to the reference point Pr.

Except for effects provided by the updating processing executed based on the sound characteristic corresponding to the reference point Pr, this modification provides the same effects as those provided by the above-described embodiment or by the above-described modifications.

In the above-described embodiment and in the above-described modifications, an example is described in which, when the updating processing is executed two or more times, the second and subsequent updating processing are executed based further on the selected characteristic and the N sound characteristics used in the previous updating processing. However, this disclosure is not limited thereto.

For example, in this modification (seventh modification), the updating processing may be executed not based on the selected characteristic and the N sound characteristics used in the previous updating processing. Except for effects provided by processing in which the second and subsequent updating processing are executed further based on the selected characteristic and the N sound characteristics used in the previous updating processing, this modification provides the same effects as those provided by the above-described embodiment or by the above-described modifications.

In the above-described embodiment and in the above-described modifications, an example is described in which the N labels LA denoting the N sound characteristics corresponding to the N specific points Ps are displayed such that the N labels LA are in one-to-one correspondence with the N specific points Ps. However, this disclosure is not limited thereto.

For example, in this modification (eighth modification), the N labels LA need not necessarily be displayed such that the N labels LA are in one-to-one correspondence with the N specific points Ps. Except for effects provided by the N labels LA displayed such that the N labels LA are in one-to-one correspondence with the N specific points Ps, this modification provides the same effects as those provided by the above-described embodiment or by the above-described modifications.

### DESCRIPTION OF REFERENCE SIGNS

10 . . . audio system, 100 . . . audio adjustment apparatus, 110 . . . processor, 112 . . . display controller, 113 . . . operation receiver, 114 . . . correspondence setter, 116 . . . identifier, 118 . . . determiner, 140 . . . storage device, 200 . . . input-output device, 300 . . . signal processor, 400 . . . sound emitter, ARop . . . operation area, Pr . . . reference point, Ps . . . specific point, Pu . . . selected point.

What is claimed is:

1. A computer-implemented audio adjustment method comprising:
causing N sound characteristics to be in one-to-one correspondence with N specific points included in an operation area for sound characteristic adjustment, where N is a natural number greater than or equal to three;
receiving an operation to specify, as a selected point, a freely selected location within the operation area;
identifying, as a selected characteristic, a sound characteristic corresponding to the selected point, based on at least one specific point among the N specific points, at least one sound characteristic corresponding to the at least one specific point, and the selected point;
determining that the selected characteristic is not to be a target sound characteristic that is set by the sound characteristic adjustment;
in response to determining that the selected characteristic is not to be the target sound characteristic, executing, based on the selected characteristic and the N sound characteristics, updating processing to update at least one of the N sound characteristics to at least one sound characteristic other than the N sound characteristics; and
in response to determining that the selected characteristic is not to be the target sound characteristic, receiving the operation again.

2. The method according to claim 1, wherein identifying of the selected characteristic comprises identifying the selected characteristic further based on a sound characteristic corresponding to a reference point within the operation area.

3. The method according to claim 2, wherein a distance from the reference point to a specific point among the N specific points is equal to a distance from the reference point to each specific point of specific points other than the specific point among the N specific points.

4. The method according to claim 2, wherein the updating processing causes the selected characteristic to correspond to the reference point.

5. The method according to claim 2, wherein the updating processing comprises processing to cause the at least one sound characteristic other than the N sound characteristics to be determined based on the selected characteristic, the N sound characteristics, and the sound characteristic corresponding to the reference point.

6. The method according to claim 1, wherein the operation area is in a shape of a polygon with the N specific points as vertices.

7. The method according to claim 6, wherein the N specific points are four specific points.

8. The method according to claim 1, comprising:
executing the updating processing two or more times; and
executing second updating processing and subsequent updating processing based further on the selected characteristic and the N sound characteristics used in previous updating processing.

9. The method according to claim 1, comprising:
causing a display to display N labels denoting the N sound characteristics such that the N labels are in one-to-one correspondence with the N specific points.

10. An audio adjustment apparatus comprising:
at least one memory configured to store instructions; and
at least one processor configured to execute the instructions to:
cause N sound characteristics to be in one-to-one correspondence with N specific points included in an operation area for sound characteristic adjustment, where N is a natural number greater than or equal to three;
receive an operation to specify, as a selected point, a freely selected location within the operation area;
identify, as a selected characteristic, a sound characteristic corresponding to the selected point based on at least one specific point among the N specific points, at least one sound characteristic corresponding to the at least one specific point, and the selected point;
determine whether the selected characteristic is to be a target sound characteristic that is set by the sound characteristic adjustment;
execute, in response to the selected characteristic not being determined to be the target sound characteristic, and based on the selected characteristic and the N sound characteristics, updating processing to update at least one of the N sound characteristics to at least one sound characteristic other than the N sound characteristics; and
receive the operation again in response to the selected characteristic not being determined to be the target sound characteristic.

11. The audio adjustment apparatus according to claim 10,
wherein the at least one processor is configured to identify the selected characteristic further based on a sound characteristic corresponding to a reference point within the operation area.

12. The audio adjustment apparatus according to claim 11, wherein a distance from the reference point to a specific point among the N specific points is equal to a distance from the reference point to each specific point of specific points other than the specific point among the N specific points.

13. The audio adjustment apparatus according to claim 11, wherein the updating processing causes the selected characteristic to correspond to the reference point.

14. The audio adjustment apparatus according to claim 11, wherein the updating processing comprises processing to cause the at least one sound characteristic other than the N sound characteristics to be determined based on the selected characteristic, the N sound characteristics, and the sound characteristic corresponding to the reference point.

15. The audio adjustment apparatus according to claim 10, wherein the operation area is in a shape of a polygon with the N specific points as vertices.

16. The audio adjustment apparatus according to claim 15, wherein the N specific points are four specific points.

17. The audio adjustment apparatus according to claim 10,
wherein the at least one processor is configured to:
execute the updating processing two or more times; and
execute second updating processing and subsequent updating processing based further on the selected characteristic and the N sound characteristics used in previous updating processing.

18. The audio adjustment apparatus according to claim 10,
wherein the at least one processor is configured to cause a display to display N labels denoting the N sound characteristics such that the N labels are in one-to-one correspondence with the N specific points.
